(19) United States
(12) Patent Application Publication
(10) Pub. No.: US 2013/0044517 A1
(43) Pub. Date: Feb. 21, 2013

(54) ELECTRICAL LIGHTING DEVICE

(71) Applicant: Olivier Pinon, Limoges (FR)

(72) Inventor: Olivier Pinon, Limoges (FR)

(21) Appl. No.: 13/392,917

(22) PCT Filed: Aug. 27, 2010
(86) PCT No.: PCT/EP10/62536

§ 371 Date: Jul. 13, 2012

(30) Foreign Application Priority Data
Aug. 28, 2009 (FR) 09 55904

(51) Int. Cl. F21V 29/00; H01R 33/00

(52) U.S. Cl. 362/640; 362/235

(57) ABSTRACT

The present invention relates to an electrical light fixture (1) that is mounted on a bracket (2), said fixture (1) comprising: a plurality of light-emitting diodes (LEDs); as well as a means (6) for dissipating the heat generated by said diodes; and at least one transparent or semi-transparent light diffuser (4), the plurality of diodes being mounted on an array that is placed in a recess portion of an interface module (5). According to the invention, the interface module (5) includes a means for resiliently maintaining for attaching the array into the recess portion of the interface module (5), and the means for resiliently maintaining further has a surface reflecting the light thereof such that the light from the diodes is essentially diffused through the aforementioned light diffuser (4). The interface module (5) includes at least one heat pipe connected to the aforementioned dissipation means (6), in which a coolant flows for at least partially discharging the heat from the plurality of light-emitting diodes.

### TECHNICAL FIELD

This invention relates to an electrical light fixture, It relates more particularly to such a fixture comprising a plurality of light-emitting diodes (LED) intended to diffuse the light produced through a transparent or semi-transparent diffuser making it possible to create a diffused light.

### BACKGROUND

The utilisation of light-emitting diodes has the disadvantage of substantial heating which is required to be dissipated otherwise all or a portion of the lighting device can be damaged. In order to allow for an effective heat sink, several solutions have been proposed, in particular the use of heat pipes authorising the circulation of a coolant and/or ventilation systems. These solutions are known in documents US 20070086196, US 20080150126 and US 200800723720.

Another major disadvantage of the LED resides in the source of light created which does not make them suitable for harmonious lighting. Indeed, the LEDs form a white point light which is often unpleasant for the human eye, and even dangerous for the retina. That is why, currently, LEDs, although particularly economical, are hardly used to form the light source of a light fixture intended, in addition to their function aspect, to pleasantly and aesthetically diffuse the light in a generally liveable area.

Furthermore, LEDs constitute a new type of lighting and consumption products on the market with which are not very familiar. Indeed, because the LEDs create a point light and often of low power (less than 1 Watt), they are often combined, within a lighting device, in the form of a plurality of elements mounted on a unit/module. This in general complicates the maintenance, i.e. in particular the replacing of one or more used LEDs, as, contrary to a conventional electric light bulb, there are no inexpensive and practical systems on the market that allow the non-professional consumer to replace a single LED in a unit/module of LEDs, without changing all of the LEDs in this unit/module, and even the lighting device itself. That is why, in spite of a competitive cost at purchase and with regards to electrical consumption, lighting devices comprising LEDs are not chosen by, the majority of consumers, due to the particularly high cost of maintenance, and even the absence of a possibility of maintenance for replacing used LEDs.

### SUMMARY

The invention has for purpose to overcome the disadvantages of LED lighting systems of the prior art by proposing a solution for a fast and economical maintenance and an indirect diffusion of the light that is particularly effective and aesthetic.

To this effect, this invention relates to an electrical light fixture, mounted on a bracket, said fixture comprising,

a plurality of light-emitting diodes (LED), as well as

means for dissipating the heat generated by said diodes,

at least one transparent or semi-transparent light diffuser,

the plurality of diodes being mounted on an array arranged in a recess portion of an interface module.

According to an aspect of the invention, the interface module comprises means for resiliently maintaining to attach the array in the recess portion of the interface module and these means for resiliently maintaining further have a surface reflecting the light in such a way that the light coming from the diodes is diffused substantially through aforementioned light diffuser; furthermore the interface module comprises at least one heat pipe connected to the aforementioned means for dissipating wherein flows a coolant intended to discharge at least partially the heat coming from the plurality of light-emitting diodes.

The expression “transparent or semi-transparent light diffuser” means an element that is at least substantially transparent, i.e. an element allowing for vision through it by the human eye in such a way as to distinguish at least one shape and/or an outline that is relatively precise located on the other side of said diffuser.

Moreover, the expression the “the light coming from the diodes is diffused substantially through the aforementioned light diffuser” means the fact that more than 60%, more preferably more than 80%, of the light corning from the light-emitting diodes passes through or in the optical diffuser.

Thanks to this invention, non-professional users benefit from an electrical light fixture, in particular but not exclusively intended for an at least partially closed living area, easy to maintain and creating a diffused light through an element for an aesthetic effect and ambiance that are particularly appreciable.

Other characteristics shall appear in the description of a non-restricted embodiment of the invention:

more preferably, the light diffuser is made of polymethyl methacrylate, acrylic, polycarbonate, polyester, glass or ceramic;

according to an embodiment of the invention, an upper portion of the interface module has a guide surface of the array with lateral protruding portions, the means for maintaining being attached on said protruding portions while the array of LEDs is attached pressing against the interface module;

in this case, the means for maintaining consisting in at least two profiled sections, respectively attached on each of the two protruding portions, maintaining, the array pressing against the interface module;

advantageously, the light fixture comprises at least one plate with high thermal conductivity (greater than 200 W .m⁻¹.K⁻¹ at a temperature of 20° C.) arranged between the array of LEDs and the interface module;

advantageously, at least one of the ends of the array of LEDs comprises a means for grasping, such as a tab, intended to authorise the grasping by a user for the withdrawal of said array;

advantageously, the interface module comprises two portions fixed together surrounding the aforementioned heat pipe. Of course, it can be provided that the heat pipe or pipes are welded directly onto the module interface,

according to a possible embodiment of the invention, the light diffuser is attached removably to the interface module thanks to at least two U-shaped lateral rails engaged with the edges of the light diffuser;

the light fixture of the invention is able to be connected, for example via wires, to a remote electrical power supply network and/or it comprises a source of electrical power.

Furthermore, according to another embodiment of the invention, the means for resiliently maintaining include a first profiled section articulated such as to pivot and cooperating with a first portion of a second profiled section a second portion of which is able to reflect the light.

More precisely, the first profiled section comprises a longitudinal sleeve, the exterior profile of which is in the shape of a cam, and the interior profile of which has a hole on a portion of its length and the first portion of the second profiled section comprises at least one sleeve longitudinally inserted into the longitudinal sleeve of the first profiled section in such a way that an axis can be recessed longitudinally in the hole of the first profiled section and in the sleeve of the second profiled section in order to realise said pivot connection.

Advantageously, said first profiled section has a substantially semi-cylindrical curved shape and is provided with a longitudinal protrusion directed towards the interior of the fixture.

According to another characteristic, the means for resiliently maintaining include a third profiled section having a first plane provided with an opening for the recess of at least one diode said plane being inserted between said interface module and the light diffuser, the third profiled section comprising a second plane substantially perpendicular to said first plane and able to be used as a element of grasping, one of the edges of the second plane of the third profiled section cooperating with the protrusion of the first profiled section in order to resiliently maintain in pressing said array.

### BRIEF DESCRIPTION OF THE DRAWINGS

The invention is described hereinafter in more detail using non-restricted figures showing preferred embodiments of the invention.

FIG. 1 is a diagrammatical view of the rear of an electrical light fixture according to a first embodiment of the invention;

FIG. 2 is a side view of the fixture according to the invention shown in FIG. 1;

FIG. 3 is a perspective view of an embodiment of the means for dissipating energy of an electrical light fixture according to the invention;

FIG. 4 is a diagrammatical view of the interface module whereon is mounted the array comprising the plurality of light-emitting diodes with a portion of the diffuser, according to a first embodiment of the invention;

FIG. 5 shows a section of the interface module and of the light diffuser shown in FIG. 4;

FIG. 6 is a view of the interface module and of the array of light-emitting diodes of the electrical light fixture according to the first embodiment of the invention;

FIG. 7 is an exploded view of a light fixture according to a second embodiment of the invention;

FIG. 8, a transversal section of a portion of the light fixture according to FIG. 7; and

FIG. 9, an enlarged transversal section of FIG. 8.\

### DETAILED DESCRIPTION

The electrical light fixture 1 according to the invention can have all types of shapes and the annexed figures show substantially two embodiments in order to illustrate the invention, knowing that the implementation of shapes and dimensions can vary substantially in order to achieve a decorative originality, while still remaining within the scope and framework of the claims.

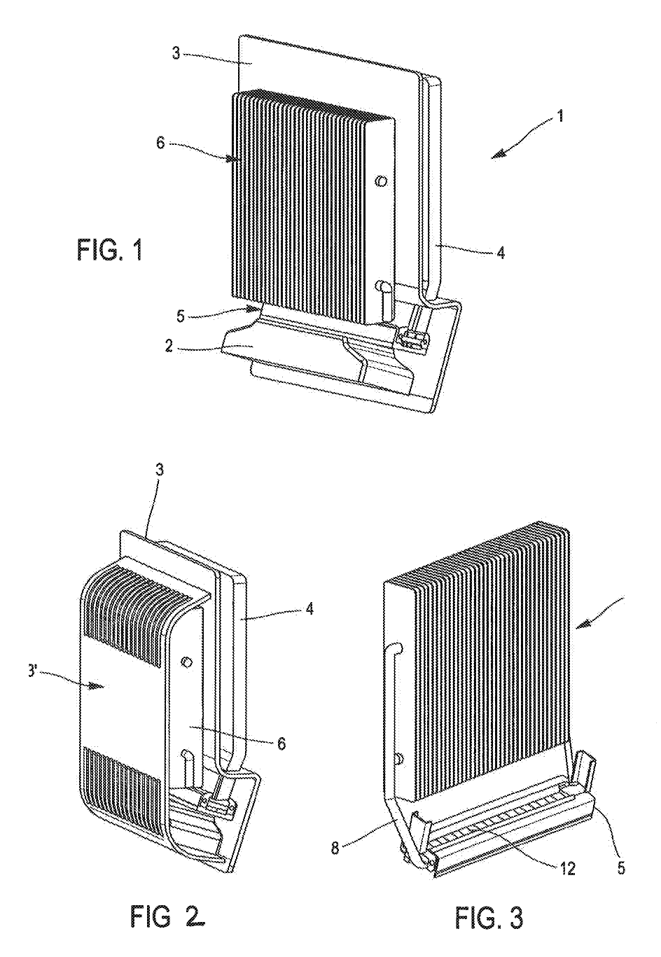

As such, in FIG. 1, the fixture 1 substantially has the shape of a screen having a bracket 2 in order to place said fixture 1 on a flat surface. In this embodiment, when the fixture 1 is placed on a flat surface, the screen 4 formed substantially by the lighted diffuser is inclined in relation to the vertical, in the example in FIG. 2, the only additions in relation to the embodiment of FIG. 1 consist in a protective cover 3′ making it possible to dissimulate, protect the interface module 5 and the means for dissipating the heat 6 generated by the diodes and serve as a bracket to the fixture 1 which still providing the proper flow of air in the required fixture on the heat sink (the hot air escapes via the orifices of the upper portion).

The light fixture 1 comprises an interface module 5 used to attach the plurality of diodes 7 intended for the lighting and circulate at least one pipe or tube 8, 8′ for the circulation of a coolant allowing for the recovery of the thermal energy generated by the diodes 7 during their operation. In the example chosen to illustrate the invention in FIG. 5, the interface module 5 comprises two tubes or pipes 8, 8′ for the passage and the circulation of a coolant. Of course, more tubes/pipes 8, 8′ can be provided.

The interface module 5 here comprises two main portions, one upper 10 and the other lower 11, attached together via traditional means, for example via welding or screwing, in such a way as to recess said heat exchange pipe(s) 8, 8′. The upper portion 10 has an H-shaped section to recess one side; towards the lower portion 11, these means of heat exchange 8, 8′; and on the other side to recess the array 12 carrying the plurality of LEDs 7. Between the array 12 and this upper portion 10 of the interface module 5 is arranged advantageously, but not necessarily, a plate 13 with (very) high thermal conductivity favouring the passage of the energy (of the heat) coming from the array 12 of LEDs 7 towards the upper portion 10 and the means of heat exchange 8, 8′.

Moreover, the array 12 of LEDs 7 is attached in a recess of the upper portion 10 of the interface module 5 via elastic fastening. This elastic fastening consists in at least two profiled sections 20, 21 attached in a conventional manner, such as by gluing or screwing, on the corresponding face of the upper portion 10 of the interface module 5 on each side surrounding the array 12 of LEDs 7 and defining a recess for the latter. These profiled sections 20, 21 are ideally made of metal but any other material can be considered with the condition of having properties of elasticity that are interesting and suited for constraining the attaching of the array 12 of LEDs 7 and allowing for its withdrawal/replacing as well as properties to strongly reflect the light, at least on its face across from the LEDs 7. As such, the means for resiliently maintaining 20, 21 exert a force of pressing in order to attach the array 12 of LEDs 7 against the interface module 5.

The elastic means for maintaining 20, 21 have their surfaces across from the LEDs 7 directed in such a way that most of the light coming from the LEDs 7 is directed, via reflection on this surface, towards the light diffuser 4, The light coining from the LEDs 7 is as such reflected almost completely towards or through the light diffuser 4, i.e. more than 60%, and even ideally more than 80% and more preferably more than 90%, The means for resiliently maintaining 20, 21, i.e. here each profiled section, further comprises at least one portion 22, 23 pressing against the array 12 of LEDs 7, the latter 12 being substantially plane, said portion 22, 23 is also flat in order to be applied in a complementary manner against the surface of the array 12 of LEDs 7. Of course, the portions 22, 23 are not necessarily flat, a line of contact (curved for example), or a multitude of contact points is sufficient to exert the function of pressing on the array.

The array 12 of LEDs 7 is a conventional array of LEDs in that it has a mounting of a plurality of LEDs on a substrate that authorises the electrical. connection of the LEDs. Moreover, the array 12 of LEDs 7 has a shape suited to its sliding and its positioning on. the interface module 5. According to an embodiment of the invention the array 12 is provided at one of its ends with a means for grasping 30 making it possible in particular for a user to pull this array 12 in order to remove it from the interface module 5.

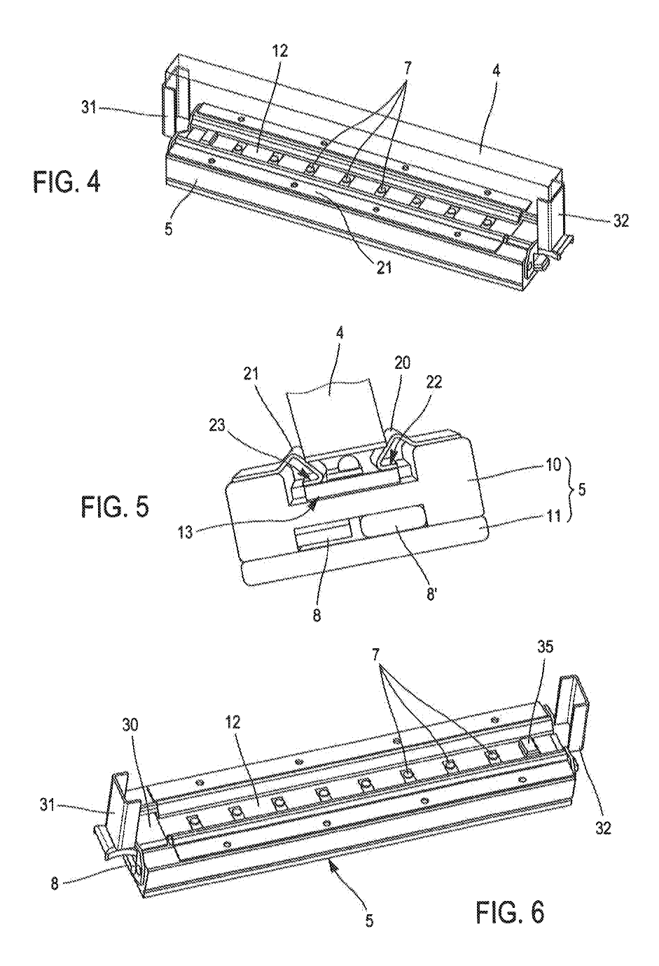

The light diffuser 4 is an element made of synthetic material, for example of polymethyl methacrylate (PMMA) or glass, and is arranged in the immediate vicinity of the LEDs 7 and of the means for resiliently maintaining 20, 21 reflecting the light in such a way as to capture all or almost all of the light emitted, either directly or via reflection. In the example embodiment in FIG. 1, the light diffuser 4 is attached by the intermediary of a panel 3 mounted on the fixture 1 and which attaches the diffuser 4, In the example embodiment shown in FIG. 4, the light diffuser 4 is attached on the fixture 1 thanks to fastening rails 31, 32 present respectively at the two ends of the interface module 5 and which surround and attach the light diffuser 4 via its edge/side.

The heat sink 6, 8, 8′ is a heat exchange system with heat pipe, i.e. the heat generated by the array 12 of LEDs 7 is transmitted by conduction to the coolant which is transported, in a closed circuit, via the heat pipes 8, 8′ to a set of heat sink fins 6 allowing for the dissipation of energy. It can also be considered to replace the heat sink fin structure with a heat sink structure made of metal/ceramic foam or with a heat sink structure with a honeycomb structure, not shown in the annexed figures but known to heat exchanger systems.

As is shown in FIG. 1, the fixture 1 can include, in addition to the main elements which are the interface module 5, the light diffuser 4 and the heat sink 6, 8, 8′ other functional and/or decorative elements, in particular the panel 3 which makes it possible to conceal from sight certain portions of the fixture 1 and to reflect, possibly onto a treated/coloured surface, the light coming from the light diffuser 4.

When operating, the light coming from this light fixture 1 is diffused and modelled according to the shape and/or colours of the light diffuser 4. When a user wants to replace its array 12 of LEDs 7, for example because at least one LED 7 is defective and the light produced is less intense, the user does not have to purchase a new light fixture 1 but only to obtain a new array of LEDs for possible the defective LED) and replace that present on the interface module 5.

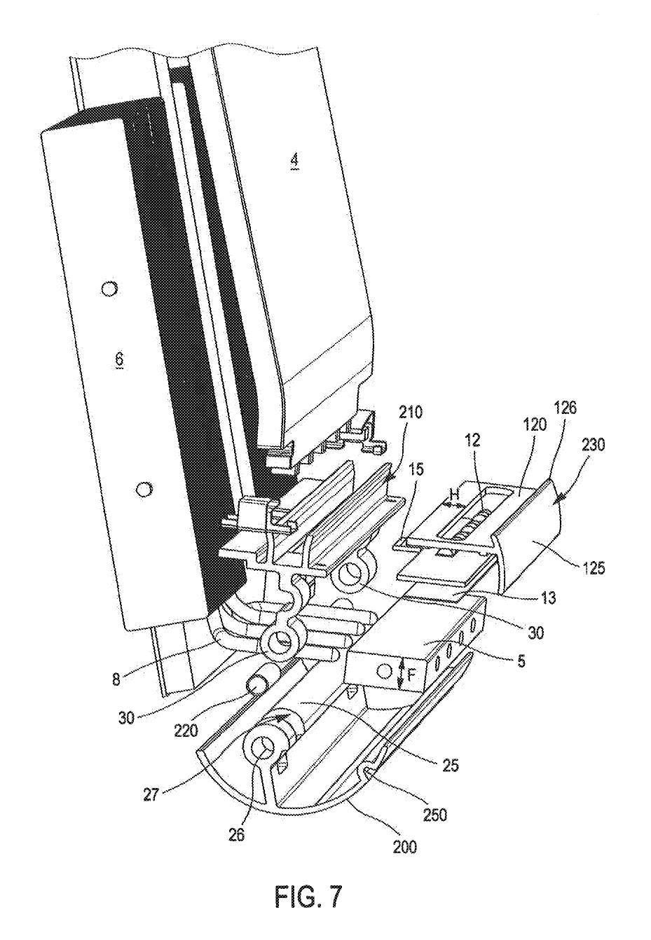

FIG. 7 therefore shows the main items that comprise a light fixture according to a second embodiment of the invention. More precisely this includes the means for resiliently maintaining in the form of a first profiled section 200 which cooperates with a second profiled section 210 and an axis or shaft 220 which makes possible a pivot connection between the first and second profiled sections. The other elements of the light fixture are identical to those of the first embodiment, therefore have the same references and shall not he described any further.

The first profiled section 200, which extends according to the length of the array 12, comprises an element or longitudinal sleeve 25, the exterior profile of which is in the shape of a cam, i.e. non-cylindrical; the longitudinal element 25 preferably has at each of its ends a hole 26 as well as a longitudinal cut 27 allowing for the recess of a sleeve 30 which is part of a second profiled section 210. For reasons of balancing forces, the same mounting is provided at each end of the longitudinal element 25, although this characteristic is not mandatory. The axis or shaft 220 is inserted through the hole 26 and the sleeve 30, which are of course mounted coaxially. This mounting constitutes the pivot connection between the first 200 and the second 210 profiled section.

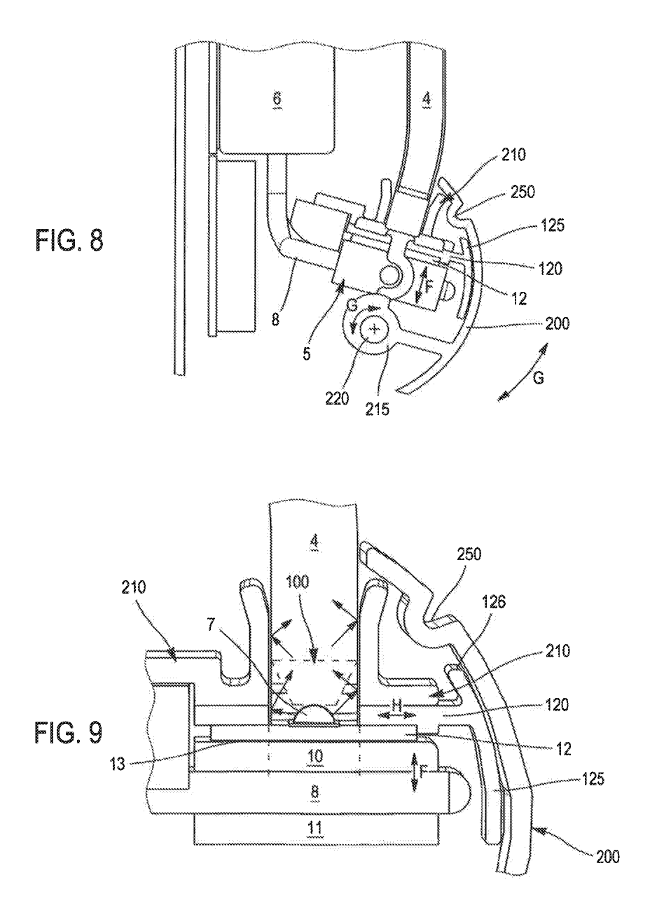

As such the first profiled section 200 can pivot according to its longitudinal axis, with regards to the second profiled section 210. The rotation takes place around the axis 220 and the exterior profile in the shape of a cam of the element 25 allows for a translation of the interface module 5 in a transversal plane, as shown by the double arrows F in FIGS. 8 and 9. The module 5 is indeed maintained in contact with the cam as shown in FIG. 8 in particular.

The first profiled section 200 further comprises a portion that advantageously has a semi-cylindrical shape. This portion further comprises a longitudinal protrusion 250 directed towards the interior of the fixture. This protrusion serves as a stop in order to retain the first profiled section 200 in covering position; it as such allows for the resilient maintaining of the array 12 against the module 5.

Moreover the second profiled section 210 comprises a second upper portion comprising two L-shaped flanges between which are positioned the light diffuser 4, via its edge. FIGS. 8 and 9 clearly show this arrangement, FIG. 9 showing via a set of small arrows the diffusion of the light from the diodes 7. As such a privileged space 100 for the diffusion of the light is created just above the diodes 7, which induces a homogenous light through the entire diffuser 4.

Without leaving the scope of the invention the first portion and the second portion of the second profiled section 210 can constitute two separate portions. Those skilled in the art will chose according to the possibilities and material constraints of realising the invention.

Furthermore the diodes 7 are advantageously positioned through a hole of a third profiled section 230 constituted of a first plane 120 inserted between a face of the second profiled section 210 and the array 12 which is based on the interface module 5. The third profiled section 230 comprises a second plane 125 substantially perpendicular to the first plane 120. This mounting allows through a translation according to the arrow H of FIGS. 7 to 10 for the third profiled section 230 as well as for the array 12 to be extracted easily from the fixture, for example in order to change the array if it no longer functions, or if one wishes to replace it with another having different characteristics.

One of the longitudinal edges 126 of the second plane 125 of the third profiled section 230 cooperates favourably with the longitudinal protrusion 250 in order to maintain the third profiled section 230 in covering position on the fixture. FIGS. 8 and 9 show this position.

By pivoting the first profiled section 200 around the axis 220 it is therefore possible to more or less compress the second profiled section 210 against the first profiled section 200 or more precisely to resiliently maintain the array 12 against the interface module 5. When the first profiled section 200 is lowered, it in particular uncovers the third profiled section 230 which can as such he extracted outside of the fixture, with the array 12, via a simple translation according to the arrow H.

This manipulation is extremely simple and without risk. The user will appreciate the improvement in the maintenance of such a fixture.

Of course a connector 15 (visible in FIG. 7) will be provided in order to allow for the connection of the array 12 for example to an exterior source of electrical power.

1-13. (canceled)

14. An electrical light fixture, mounted on a bracket, the fixture comprising:
a plurality of light-emitting diodes (LEDs);
means for dissipating the heat generated by the light-emitting diodes; and
at least one transparent or semi-transparent light diffuser;
the plurality of light-emitting diodes being mounted on an array arranged in a recess portion of an interface module,
wherein the interface module comprises means for resiliently maintaining in order to attach the array in the recess portion of the interface module and wherein the means for resiliently maintaining includes a surface reflecting light in such a way that the light coming from the light-emitting diodes is diffused substantially through the light diffuser and wherein the interface module comprises at least one heat pipe connected to the means for dissipating for circulating a coolant intended to discharge at least partially the heat coming from the plurality of light-emitting diodes.

15. The light fixture according to claim 14, wherein the light diffuser is made of a material selected from the group consisting of polymethyl methacrylate; acrylic, polycarbonate, polyester, glass and ceramic.

16. The light fixture according to claim 14, wherein an upper portion of the interface module has a guide surface of the array with lateral protruding portions, the means for maintaining being attached on the protruding portions while the array of LEDs is attached pressing against the interface module.

17. The light fixture according to claim 16, wherein the means for maintaining consist in at least two profiled sections, respectively attached on each of the two protruding portions, maintaining the array pressing against the interface module.

18. The light fixture according to claim 14, further comprising at least one plate with strong thermal conductivity arranged between the array of LEDs and the interface module.

19. The light fixture according to claim 14, wherein at least one of the ends of the array of LEDs comprises a means for grasping intended to authorise the grasping by a user for the withdrawal of the array.

20. The light fixture according to claim 14, wherein the interface module comprises two portions attached together and surrounding the heat pipe.

21. The light fixture according to claim 14, wherein the light diffuser is attached removably to the interface module thanks to at least two lateral U-shaped rails engaged with the edges of the light diffuser.

22. The light fixture according to claim 14, wherein the means for resiliently maintaining include a first profiled section pivotably articulated and cooperating with a first portion of a second profiled section of which a second portion is able to reflect the light.

23. The light fixture according to claim 22, wherein the first profiled section comprises a longitudinal sleeve of which the exterior profile is in the shape of a cam, and of which the interior profile has a hole over a portion of its length and wherein the first portion of the second profiled section comprises at least one sleeve longitudinally inserted into the longitudinal sleeve of the first profiled section in such a way that an axis can be recessed longitudinally in the hole of the first profiled section and in the sleeve of the second profiled section in order to realise a pivot connection

24. The light fixture according to claim 22, wherein the first profiled section has a substantially semi-cylindrical curved shape and is provided with a longitudinal protrusion directed towards an interior of the fixture.

25. The light fixture according to claim 22, wherein the means for resiliently maintaining include a third profiled section having a first plane provided with an opening for the recess of at least one diode, the first plane being inserted between the interface module and the light diffuser, the third profiled section comprising a second plane substantially perpendicular to the first plane and able to be used as an element for grasping, one of the edges of the second plane of the third profiled section cooperating with the protrusion of the first profiled section in order to resiliently maintain in pressing the array.

26. The light fixture according to claim 14, wherein the light fixture is connectable via wires to a remote electrical power supply network.

27. The light fixture according to claim 19, wherein the means for grasping is a tab.

28. The light fixture according to claim 14, wherein the light fixture comprises a source of electrical power.
